(19) United States
(12) Patent Application Publication
(10) Pub. No.: US 2025/0348020 A1
(43) Pub. Date: Nov. 13, 2025

(54) OPTICAL PRINT HEAD AND IMAGE FORMING APPARATUS EQUIPPED WITH OPTICAL PRINT HEAD

(71) Applicant: CANON KABUSHIKI KAISHA, Tokyo (JP)

(72) Inventor: NOBUHIKO TANAKA, Tokyo (JP)

(21) Appl. No.: 19/184,343

(22) Filed: Apr. 21, 2025

(30) Foreign Application Priority Data
May 9, 2024 (JP) 2024-076839

(51) Int. Cl. G03G 15/043; B41J 2/447; G03G 15/04

(52) U.S. Cl. CPC G03G 15/043; B41J 2/447; G03G 15/04036

(57) ABSTRACT

Disclosed is an image forming apparatus in which a controller and a light-emitting chip are interconnected via a first signal line and a second signal line, the light-emitting chip operates in a first mode and a second mode, with the controller transmitting a switching signal for switching between the first mode and the second mode to the light-emitting chip via the first signal line.

### BACKGROUND

### Field

Aspects of the present disclosure generally relate to an image forming apparatus equipped with an optical print head.

### Related Art

In electrophotographic image forming apparatuses, an exposure head having a plurality of light-emitting portions arrayed therein may be used to expose a photosensitive member. The exposure head may include a light-emitting chip with a plurality of light-emitting portions mounted on a board. While various data types, e.g. image data and control data, are transmitted to the light-emitting chip, the light-emitting chip increases in scale depending on circuit configurations, so that the exposure head may grow in size or production cost of the exposure head may increase.

### SUMMARY

An aspect of the present disclosure provides an image forming apparatus includes a rotatable photosensitive member; a light-emitting chip that emits light for exposing the photosensitive member and includes a plurality of light-emitting portions arranged along an axis of rotation of the photosensitive member; a controller that outputs image data for controlling turning on and turning off at least one light-emitting portion of the plurality of light-emitting portions and control data for controlling an amount of light output by the at least one light-emitting portion; a first signal line interconnecting the controller and the light-emitting chip, the first signal line being used to transmit the image data and the control data; and a second signal line interconnecting the controller and the light-emitting chip, the second signal line being used to transmit the image data and the control data. The light-emitting chip is switchable between a first mode and a second mode. In the first mode, the light-emitting chip operates based on image data received via the first signal line and image data received via the second signal line. In the second mode, the light-emitting chip operates based on control data received via the first signal line and control data received via the second signal line. The controller transmits a switching signal for switching between the first mode and the second mode to the light-emitting chip via the first signal line.

Further features of the present disclosure will become apparent from the following description of embodiments with reference to the attached drawings.

### BRIEF DESCRIPTION OF THE DRAWINGS

FIG. 1 illustrates components of an image forming apparatus.

FIGS. 2A and 2B are perspective and profile views of an exposure head and a photosensitive member.

FIGS. 3A and 3B illustrate a printed circuit board of the exposure head.

FIG. 4 illustrates an arrangement of light-emitting elements included a light-emitting chip.

FIG. 5 is a plan view of the light-emitting chip.

FIG. 6 is a sectional view of the light-emitting chip.

FIG. 7 is a control configuration diagram for the light-emitting chip.

FIG. 8 is a block diagram of the light-emitting chip.

FIGS. 9A and 9B are state transition diagrams of the light-emitting chip.

FIG. 10 illustrates signals in respective signal lines when image data is transmitted to the light-emitting chip at the time of a one-channel input mode.

FIG. 11 illustrates signals in the respective signal lines when image data is transmitted to the light-emitting chip at the time of a two-channel input mode.

FIG. 12 illustrates signals in respective signal lines when control data is written into a register included in the light-emitting chip.

FIG. 13 illustrates signals in the respective signal lines when control data is read out from the register included in the light-emitting chip.

FIG. 14 illustrates signals in the respective signal lines when identification bits indicating a type “Disabled” are transmitted to the light-emitting chip.

FIG. 15 is a block diagram of an interface circuit.

FIG. 16 is a flowchart of processing which the interface circuit performs.

FIG. 17 is a block diagram of an interface circuit which receives, as an input, identification bits with two-channel signals.

### DESCRIPTION OF THE EMBODIMENTS

Various embodiments, features, and aspects of the disclosure will be described in detail below with reference to the drawings. However, constituent elements described in the following description are merely illustrated as examples, and the present disclosure should not be construed to be limited to embodiments described in the following description.

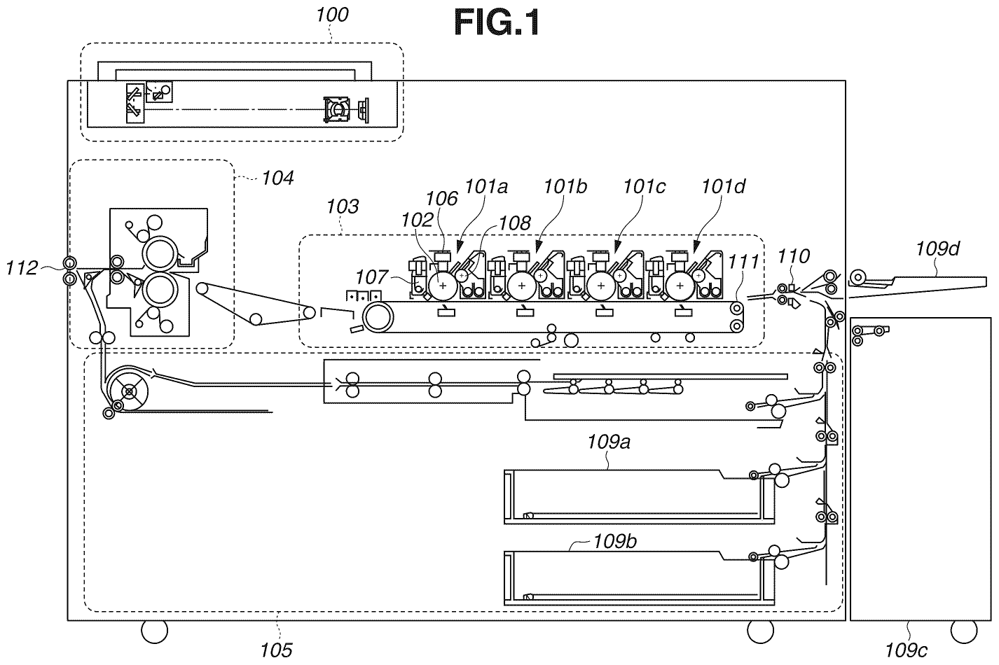

FIG. 1 illustrates components of an image forming apparatus according to an embodiment of the present disclosure. A reading unit 100 optically reads an original placed on a document positioning plate and thus generates image data representing a result of reading. An image formation section 103 forms an image on sheet based on, for example, image data generated by the reading unit 100 or based on image data received from an external device via a network.

The image formation section 103 includes image forming units 101a, 101b, 101c, and 101d. The image forming units 101a, 101b, 101c, and 101d form toner images of black, yellow, magenta, and cyan, respectively. The image forming units 101a, 101b, 101c, and 101d have respective similar configurations and, hereinafter, are also referred to collectively as an “image forming unit 101”.

During image formation, a photosensitive member 102 of the image forming unit 101 is driven to rotate clockwise as viewed in FIG. 1.

A charging device 107 electrostatically charges the photosensitive member 102.

An exposure head 106, which is an exposure device, is controlled to be lighted on and lighted off according to image data. The exposure head 106 exposes the photosensitive member 102 to light, thus forming an electrostatic latent image on the photosensitive member 102. A developing device 108 develops the electrostatic latent image formed on the photosensitive member 102 with toner. A toner image formed on the photosensitive member 102 is transferred to a sheet which is being conveyed on a transfer belt 111. Transferring toner images formed on the respective photosensitive members 102 to the sheet while overlapping the toner images each other enables reproducing a color different from each of black, yellow, magenta, and cyan.

A conveyance unit 105 controls feeding and conveyance of sheets. The conveyance unit 105 feeds a sheet from a designated unit out of internal storage units 109a and 109b, an external storage unit 109c, and a manual feed unit 109d to a conveyance path of the image forming apparatus.

The sheet, which has been fed, is conveyed to registration rollers 110. The registration rollers 110 convey a sheet onto the transfer belt 111 in such a manner that toner images on the respective photosensitive members 102 are transferred to the sheet. In the above-mentioned way, when a sheet is being conveyed on the transfer belt 111, a toner image is transferred to the sheet. A fixing unit 104 heats and presses a sheet having a toner image transferred thereto, thus fixing the toner image to the sheet. After fixing of the toner image, the sheet is discharged to outside the image forming apparatus by discharge rollers 112.

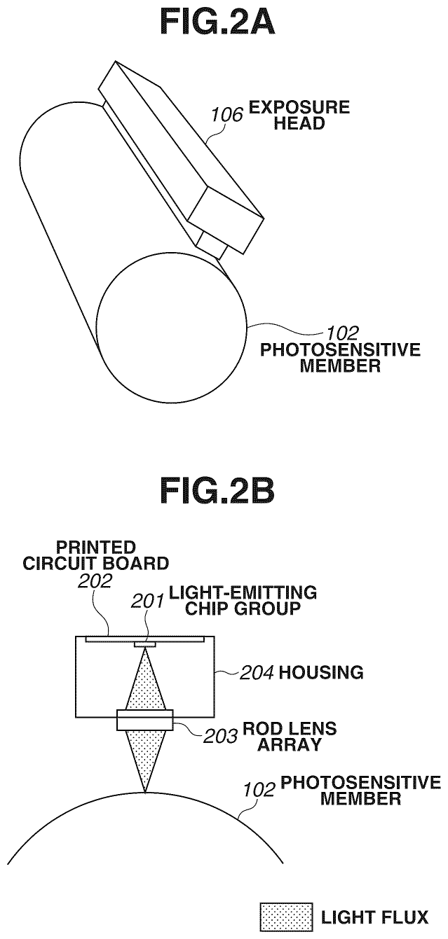

FIGS. 2A and 2B perspective and profile views of the photosensitive member 102 and the exposure head 106. The exposure head 106 includes a light-emitting chip group 201, a printed circuit board 202, on which the light-emitting chip group 201 is mounted, a rod lens array (cylindrical lens array) 203, and a housing 204, which holds the rod lens array 203 and the printed circuit board 202. The rod lens array 203 condenses light emitted from the light-emitting chip group 201 onto the photosensitive member 102, thus forming an imaging spot with a predetermined size on the photosensitive member 102.

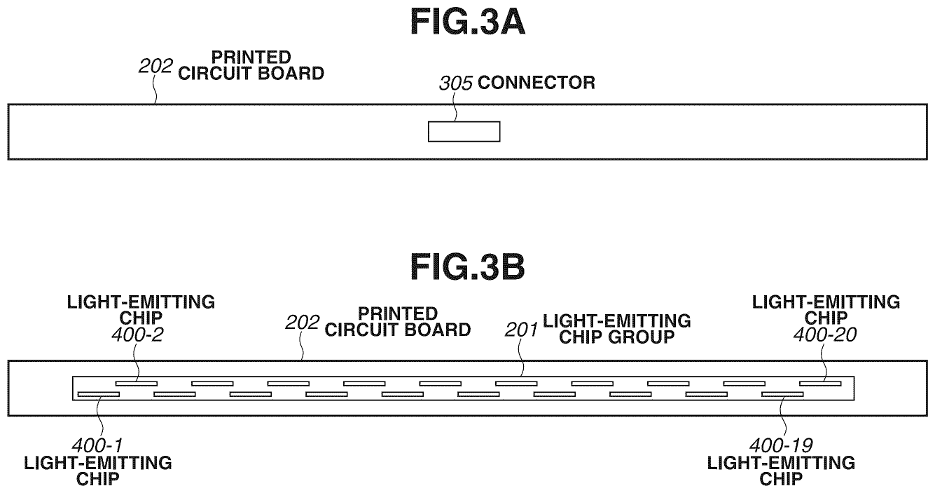

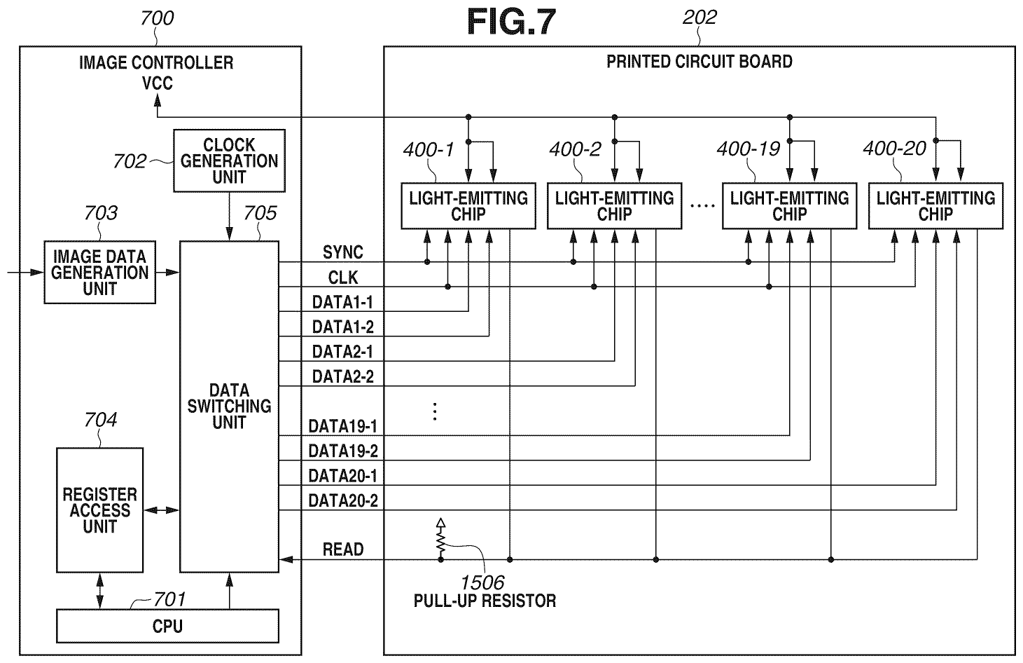

FIGS. 3A and 3B illustrate the printed circuit board 202. FIG. 3A illustrates a surface of the printed circuit board 202 on which a connector 305 is mounted, and FIG. 3B illustrates a surface of the printed circuit board 202 on which the light-emitting chip group 201 is mounted (a surface opposite to the surface on which the connector 305 is mounted). In the present embodiment, the light-emitting chip group 201 includes 20 light-emitting chips 400-1 to 400-20. The light-emitting chips 400-1 to 400-20 are arrayed in a two-line zigzag manner along the main scanning direction. In the following description, the light-emitting chips 400-1 to 400-20 are also referred to collectively as a “light-emitting chip 400”. The light-emitting chip 400 includes a plurality of light-emitting points (light-emitting elements). The light-emitting chip 400 on the printed circuit board 202 is connected to an image controller 700 (FIG. 7), which is a controller or control unit, via the connector 305.

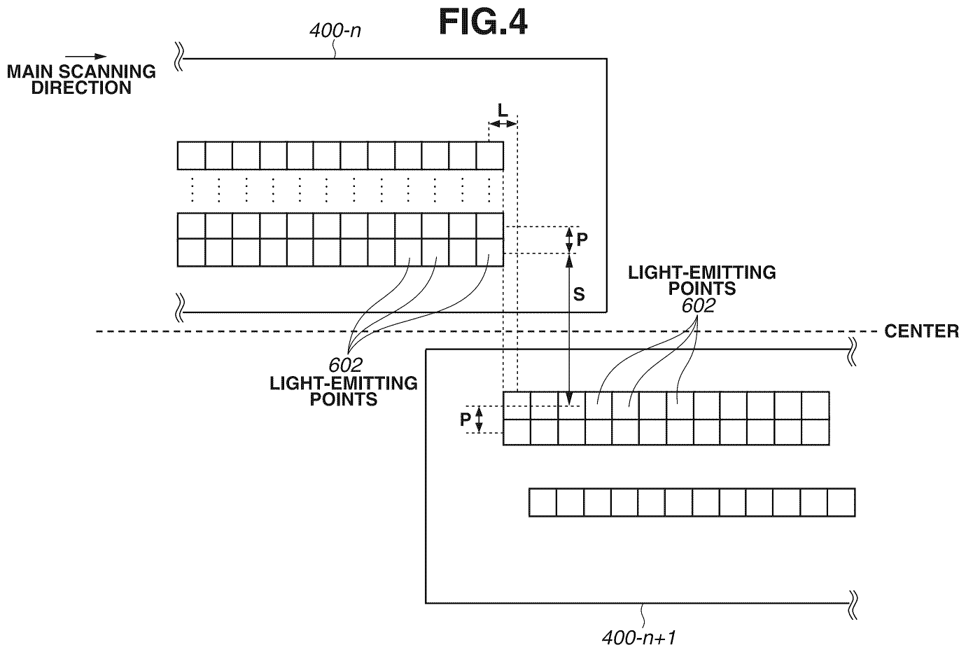

FIG. 4 illustrates an arrangement of the light-emitting points 602 provided in the light-emitting chip 400. One light-emitting chip 400 includes a plurality of sets each including 748 light-emitting points 602 arrayed along a direction parallel to the rotational axis line of the photosensitive member 102, which is the main scanning direction. The plurality of sets is arrayed along the sub-scanning direction, which is perpendicular to the main scanning direction. In this way, the light-emitting chips 400 are arranged in a two-dimensional manner along both the main scanning direction and the sub-scanning direction. In the following description, as an example, the number of sets is assumed to be four. Thus, in the following embodiment, the light-emitting chip 400 is assumed to include four sets each including 748 light-emitting points 602 arrayed along the main scanning direction, i.e., a total of 2,992 light-emitting points 602. The pitch of light-emitting points 602 adjoining in the main scanning direction is about 21.16 micrometers (μm) corresponding to a resolution of 1,200 dots per inch (dpi). Accordingly, the length in the main scanning direction of one set including 748 light-emitting points 602 is about 15.8 millimeters (mm). The pitch of light-emitting points 602 adjoining in the sub-scanning direction (the length P illustrated in FIG. 4) may be approximately 21.16 μm, corresponding to a resolution of 1,200 dpi. The pitch between respective light-emitting points 602 of two light-emitting chips 400 adjoining in the main scanning direction (the length L illustrated in FIG. 4) may also be approximately 21.16 μm, corresponding to a resolution of 1,200 dpi.

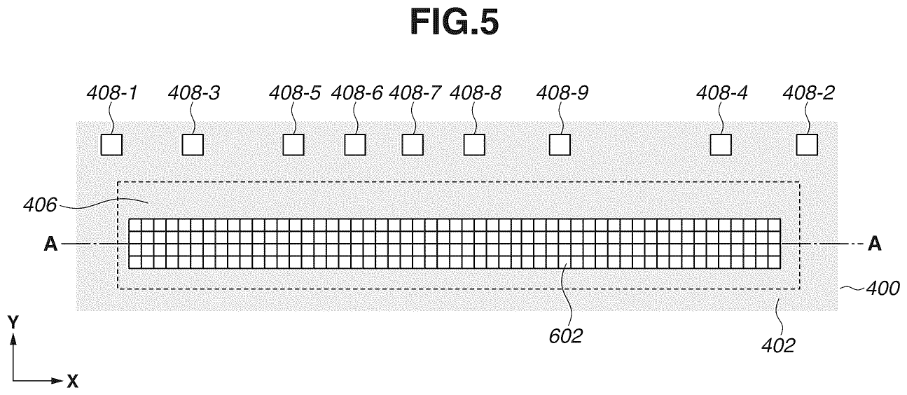

FIG. 5 is a plan view of the light-emitting chip 400. A plurality of light-emitting points 602 of the light-emitting chip 400 is formed on a light-emitting substrate 402, which is, for example, a silicon substrate. The light-emitting substrate 402 is provided with a circuit portion 406 which is configured to control a plurality of light-emitting points 602. The light-emitting chip 400 includes pads (wire bonding pads) 408-1 to 408-9, to which signal lines for communicating with the image controller 700, power source lines for connecting to a power source, and a ground line for connecting to ground are connected. The signal lines, the power source lines, and the ground line are wires made from, for example, gold.

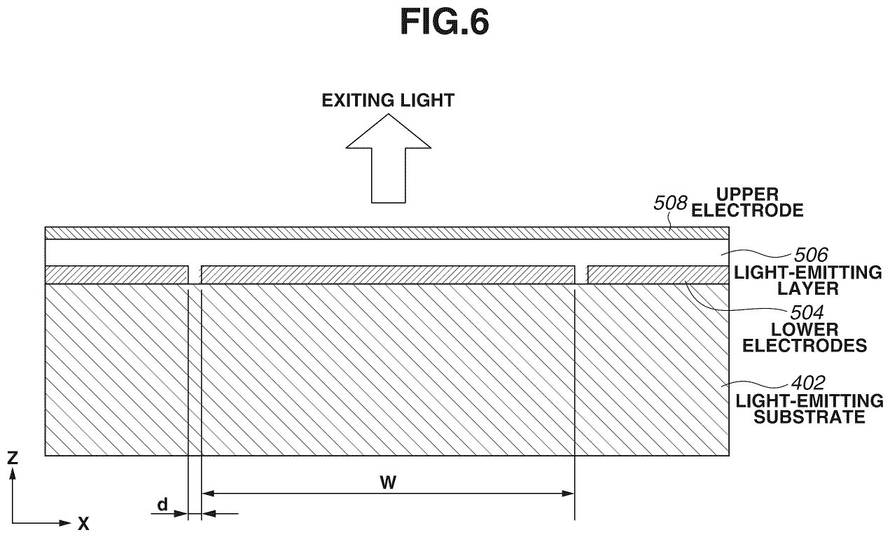

FIG. 6 illustrates a part of the cross-section taken along line A-A illustrated in FIG. 5. A plurality of lower electrodes 504 is formed on the light-emitting substrate 402. A gap with a length of d is provided between two adjacent lower electrodes 504. A light-emitting layer 506 is provided on the lower electrodes 504, and an upper electrode 508 is provided on the light-emitting layer 506. The upper electrode 508 is one common electrode associated with the plurality of lower electrodes 504. In response to a predetermined voltage being applied to between the lower electrodes 504 and the upper electrode 508, a current flows from the lower electrodes 504 to the upper electrode 508, so that the light-emitting layer 506 emits light. Accordingly, a region of the light-emitting layer 506 corresponding to the region of one lower electrode 504 corresponds to one light-emitting point 602. Thus, in the present embodiment, the light-emitting substrate 402 includes a plurality of light-emitting points. A light-emitting point may be referred to as a light-emitting portion.

The light-emitting layer 506 to be used can be, for example, an organic electroluminescence (EL) film. The light-emitting layer 506 to be used can be an inorganic EL film. The upper electrode 508 is configured with a transparent electrode made from, for example, indium tin oxide (ITO) in such a way as to allow emission wavelengths of the light-emitting layer 506 to pass through the upper electrode 508.

In the present embodiment, the entirety of the upper electrode 508 allows emission wavelengths of the light-emitting layer 506 to pass therethrough. However, the entirety of the upper electrode 508 does not need to allow emission wavelengths of the light-emitting layer 506 to pass therethrough, and a region of the upper electrode 508 from which light from the light-emitting point 602 is caused to exit may be configured to allow the emission wavelengths to pass therethrough.

In the present embodiment, the light-emitting layer 506 is provided in common with each the lower electrodes 504 provided in the light-emitting chip 400, without being limited thereto. For example, a configuration in which a first plurality of lower electrodes 504 out of a plurality of lower electrodes 504 provided in the light-emitting chip 400 is covered by a first light-emitting layer 506 and a second plurality of lower electrodes 504 out of the plurality of lower electrodes 504 provided in the light-emitting chip 400 is covered by a second light-emitting layer 506 can be employed. Even in such configuration, a region of the light-emitting layer 506 corresponding to the region of one lower electrode 504 corresponds to one light-emitting point 602. The light-emitting layer 506 can be individually provided with respect to each of a plurality of lower electrodes 504 provided in the light-emitting chip 400. Even in such a configuration, a region of the light-emitting layer 506 corresponding to the region of one lower electrode 504 corresponds to one light-emitting point 602.

FIG. 7 illustrates a control configuration for the plurality of light-emitting chips 400-1, 400-2, . . . 400-20.

A data switching unit 705 and a light-emitting chip 400-n (n being an integer of 1 to 20) are interconnected by a plurality of signal lines (wires). The data switching unit 705 and the light-emitting chip 400-n are interconnected by signal lines DATAn-1 and DATAn-2 and a signal line READ. The signal line READ is one signal line to which a total of 20 signal lines from the respective light-emitting chips 400-n are connected, and is pulled up to a predetermined first electric potential via a pull-up resistor 1506 in the printed circuit board 202.

The signal lines DATAn-1 and DATAn-2 are used for the data switching unit 705 to transmit image data to the light-emitting chip 400-n . There are two types of transmission methods for image data, referred to as a one-channel input mode and a two-channel input mode, respectively. In the one-channel input mode, the data switching unit 705, which is included in the image controller 700 serving as a controller or control unit, uses only the signal line DATAn-1 to transmit image data to the light-emitting chip 400-n . Then, the light-emitting chip 400-n uses only the signal line DATAn-1 to receive image data. In the two-channel input mode, the data switching unit 705 uses the signal lines DATAn-1 and DATAn-2 to transmit image data to the light-emitting chip 400-n . Then, the light-emitting chip 400-n uses the signal lines DATAn-1 and DATAn-2 to receive image data. Thus, the signal line DATAn-1 corresponds to a first signal line, and the signal line DATAn-2 corresponds to a second signal line. Due to being able to transmit twice the amount of data within the same period of time as compared with the one-channel input mode, the two-channel input mode may be used to transmit image data at high speed along with an increase in print speed.

The signal lines DATAn-1 and DATAn-2 are used for the data switching unit 705 to write control data into a register included in the light-emitting chip 400-n or for the data switching unit 705 to notify the light-emitting chip 400-n of reading-out of control data. The signal line READ is used for the data switching unit 705 to read out control data stored in the register included in the light-emitting chip 400-n . In response to control data being written into the register included in the light-emitting chip 400-n , in which of the one-channel input mode and the two-channel input mode the light-emitting chip 400-n operates is set.

The data switching unit 705 and all of the light-emitting chips 400 are interconnected by one signal line CLK and one signal line SYNC. The signal line CLK is used to transmit a clock signal which is used for transmission and reception of data in the signal lines DATAn-1 and DATAn-2 and the signal line READ. The data switching unit 705 outputs, to the signal line CLK, a clock signal which the data switching unit 705 has generated based on a reference clock signal received from a clock generation unit 702. The signal to be transmitted to the signal line SYNC is described below.

A central processing unit (CPU) 701 controls the entire image forming apparatus. An image data generation unit 703 performs various image processing operations such as halftone processing on image data received from the reading unit 100 or an external device, and thus generates image data for controlling turning-on and turning-off of light emission of the light-emitting points 602 of the light-emitting chip 400. The image data generation unit 703 transmits the generated image data to the data switching unit 705. At the time of writing of control data into the register included in the light-emitting chip 400, a register access unit 704 receives the control data from the CPU 701 and then transmits the received control data to the data switching unit 705. The register access unit 704 outputs, to the CPU 701, control data read out from the register included in the light-emitting chip 400.

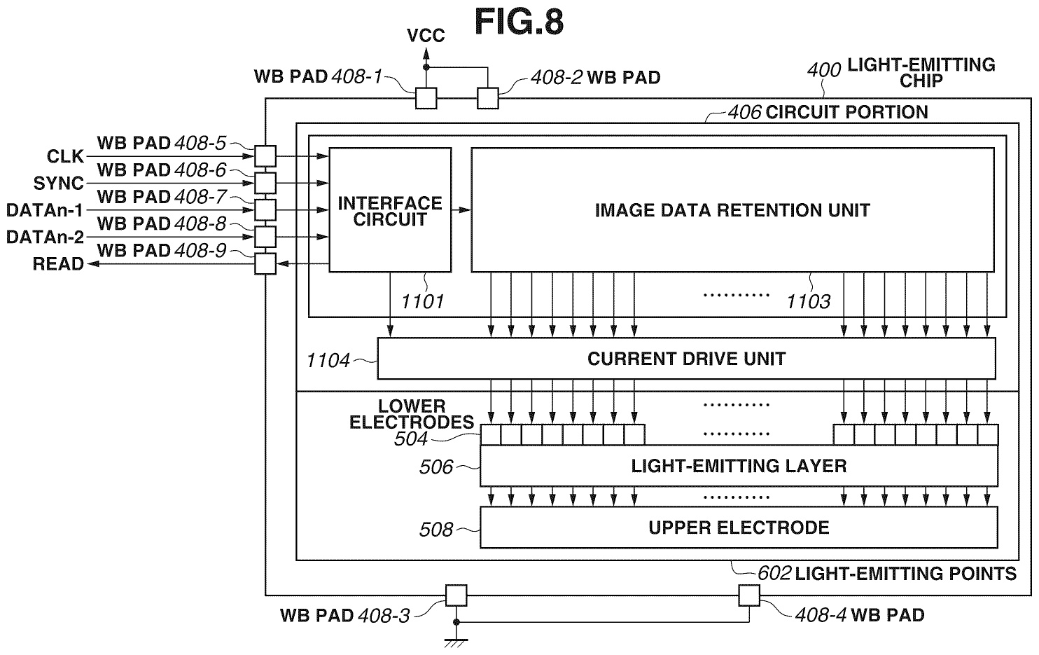

FIG. 8 is a block diagram of the light-emitting chip 400. As also illustrated in FIG. 5, the light-emitting chip 400 includes nine pads (wire bonding (WB) pads) 408-1 to 408-9. The pad 408-1 and the pad 408-2 are connected to a power source voltage VCC by a power source line. Electric power caused by the power source voltage VCC is supplied to each circuit included in the circuit portion 406 of the light-emitting chip 400. The pad 408-3 and the pad 408-4 are connected to ground by a ground line. Each circuit included in the circuit portion 406 and the upper electrode 508 are connected to ground via the pad 408-3 and the pad 408-4.

An interface circuit 1101 is connected to the signal lines CLK, SYNC, DATAn-1, DATAn-2, and READ via the pads 408-5 to 408-9 and internal signal lines of the light-emitting chip 400. The interface circuit 1101 is connected to an image data retention unit 1103 and a current drive unit 1104 via internal signal lines of the light-emitting chip 400. The interface circuit 1101 generates image data corresponding to the light-emitting points 602 based on image data transmitted from the data switching unit 705, and then transmits the generated image data to the image data retention unit 1103. The interface circuit 1101 includes a register portion, and control data indicating control information is stored in the register portion. The control data includes, for example, a setting value for designating the one-channel input mode or the two-channel input mode, a drive voltage setting value to be transmitted to the current drive unit 1104, and a setting value for setting the amount of light of the light-emitting chip 400. The details of the interface circuit 1101 are described below.

The image data retention unit 1103 generates a drive signal for controlling light emission of the light-emitting points 602 based on image data corresponding to the light-emitting points 602 received from the interface circuit 1101, and then outputs the generated drive signal to the current drive unit 1104.

The current drive unit 1104 includes 2,992 light emission drive circuits respectively corresponding to 2,992 light-emitting points 602. The current drive unit 1104 receives the drive voltage setting value from the interface circuit 1101 and causes the light-emitting points 602 to emit light with the light emission intensity corresponding to the received drive voltage setting value. A digital-to-analog (D/A) converter included in the current drive unit 1104 receives the drive voltage setting value as a digital value and divides a reference voltage generated from the power source voltage VCC based on the drive voltage setting value, thus generating a drive voltage (analog value) corresponding to the digital value. The current drive unit 1104 applies a drive voltage to the light-emitting layer 506 of a light-emitting point 602 to cause a current to flow through the light-emitting layer 506 during a period in which the drive signal received from the image data retention unit 1103 indicates high level meaning turning-on of light emission, thus causing the light-emitting point 602 to emit light.

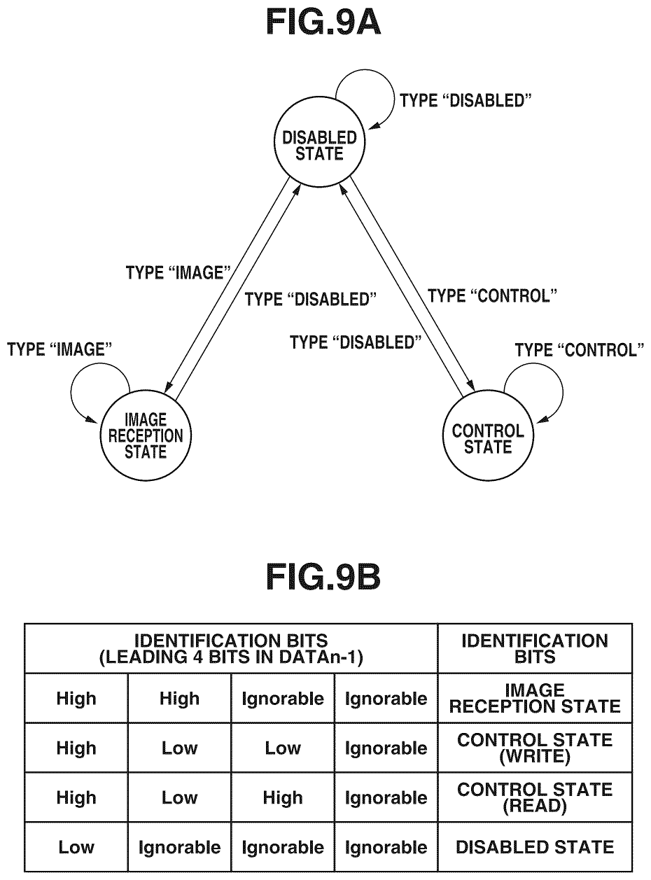

FIGS. 9A and 9B are state transition diagrams of the light-emitting chip 400. The interface circuit 1101, which is included in the light-emitting chip 400, manages the state of the light-emitting chip 400 based on identification bits (four bits) which are received in the signal line DATAn-1 in synchronization with rising of a signal which is received in the signal line SYNC.

The initial state of the light-emitting chip 400 is a disabled state. When being supplied with electric power by the power source voltage VCC, the light-emitting chip 400 enters into the disabled state.

When, in the disabled state, having received identification bits “Low, Ignorable, Ignorable, Ignorable” indicating the type “Disabled”, the light-emitting chip 400 remains in the disabled state. In the disabled state, the light-emitting chip 400 only receives identification bits, and does not perform, for example, data transmission to other circuits. Thus, the disabled state corresponds to a third mode. The identification bits indicating the type “Disabled” correspond to a third signal.

When, in the disabled state, having received identification bits “High, High, Ignorable, Ignorable” indicating the type “Image”, the light-emitting chip 400 transitions to an image reception state. In this case, the interface circuit 1101 generates image data corresponding to the light-emitting points 602 based on image data which is received in the signal lines DATAn-1 and DATAn-2 following such received identification bits, and transmits the generated image data to the image data retention unit 1103. Thus, the image reception state corresponds to a first mode. The identification bits indicating the type “Image” correspond to a first signal.

When, in the image reception state, having received identification bits “High, High, Ignorable, Ignorable” indicating the type “Image”, the light-emitting chip 400 remains in the image reception state. In this case, the interface circuit 1101 generates image data corresponding to the light-emitting points 602 based on image data which is received in the signal lines DATAn-1 and DATAn-2 following such received identification bits, and transmits the generated image data to the image data retention unit 1103. On the other hand, when, in the image reception state, having received identification bits “Low, Ignorable, Ignorable, Ignorable” indicating the type “Disabled”, the light-emitting chip 400 transitions to the disabled state.

When, in the disabled state, having received identification bits “High, Low, Low, Ignorable” or “High, Low, High, Ignorable” indicating the type “Control”, the light-emitting chip 400 transitions to a control state.

In the case of the identification bits “High, Low, Low, Ignorable”, the interface circuit 1101 performs write of control data into the register included in the interface circuit 1101 based on data which is received in the signal line DATAn-1 following such identification bits. In the case of the identification bits “High, Low, High, Ignorable”, the interface circuit 1101 performs read of control data stored in the register included in the interface circuit 1101 based on data which is received in the signal line DATAn-1 following such identification bits. Thus, the identification bits indicating the type “Control” correspond to a second signal.

When, in the control state, having received identification bits “High, Low, Low, Ignorable” or “High, Low, High, Ignorable” indicating the type “Control”, the light-emitting chip 400 remains in the control state. In this case, the interface circuit 1101 performs write or read of control data into or from the register included in the interface circuit 1101 based on data which is received in the signal line DATAn-1 following such identification bits. Thus, the control state corresponds to a second mode. On the other hand, when, in the control state, having received identification bits “Low, Ignorable, Ignorable, Ignorable” indicating the type “Disabled”, the light-emitting chip 400 transitions to the disabled state.

When, in the image reception state, having received identification bits “High, Low, Low, Ignorable” or “High, Low, High, Ignorable” indicating the type “Control”, the light-emitting chip 400 remains in the image reception state. In this case, the interface circuit 1101 determines that data which is received in the signal line DATAn-1 until next identification bits are received is neither image data nor control data, and discards such received data without performing, for example, outputting thereof to another circuit. Likewise, when, in the control state, having received identification bits “High, High, Ignorable, Ignorable” indicating the type “Image”, the light-emitting chip 400 remains in the control state. In this case, the interface circuit 1101 determines that data which is received in the signal line DATAn-1 until next identification bits are received is neither image data nor control data, and discards such received data without performing, for example, outputting thereof to another circuit.

In this way, in the present embodiment, a configuration in which a direct transition from the image reception state to the control state and a direct transition from the control state to the image reception state are inhibited and a transition between the image reception state and the control state is performed via the disabled state is employed. This configuration is employed to prevent or reduce an issue in which an error occurs in identification bits due to, for example, external noise or static electricity and the interface circuit 1101 thus malfunctions. Thus, in the present embodiment, when being in the control state, the light-emitting chip 400 transitions to the disabled state in response to the type “Disabled” bits and then, transitions to the image reception state in response to the type “Image” bits. Additionally, when in the image reception state, the light-emitting chip 400 transitions to the disabled state in response to the type “Disabled” bits and then transitions to the control state in response to the type “Control” bits. Accordingly, a switching signal for switching between the control state and the image reception state corresponds to the type “Disabled” bits and the type “Image” bits and to the type “Disabled” bits and the type “Control” bits. In the present embodiment, in consideration of a malfunction due to noise, a configuration in which switching between the control state and the image reception state is performed via the disabled state is employed. However, the method of state transition is not limited to this configuration, but a configuration in which a direct transition is performed between the control state and the image reception state can be employed.

In the present embodiment, to ensure an internal processing time in the interface circuit 1101 at the time of state transition, a configuration in which the fourth bit “Ignorable” is provided in the identification bits. The identification bits can be configured to have the number of bits different from four bits.

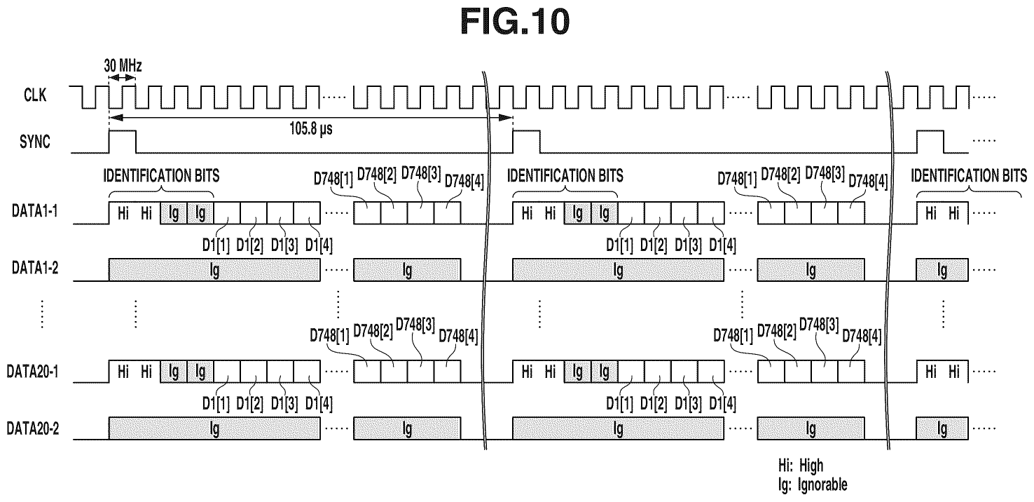

FIG. 10 to FIG. 14 illustrate signals in the respective signal lines in a case where the data switching unit 705 outputs data of for the respective types to the light-emitting chip 400. In FIG. 10 to FIG. 14, it is assumed that the case where the level of the signal is High (high) corresponds to the bit value being “1” and the case where the level of the signal is Low (low) corresponds to the bit value being “0”.

FIG. 10 illustrates signals in the respective signal lines in a case where the data switching unit 705 outputs image data to the light-emitting chip 400 in the one-channel input mode. In a case where the data type is “Image”, a line synchronization signal indicating exposure timing of one line in the photosensitive member 102 is output to the signal line SYNC. In the present example, the circumferential velocity of the photosensitive member 102 is set to 200 millimeters per second (mm/s) and the resolution in the sub-scanning direction is set to 1,200 dpi (about 21.16 μm). Accordingly, the line synchronization signal is output at intervals of about 105.8 microseconds (μs), which is a period for which the surface of the photosensitive member 102 moves about 21.16 μm. The data switching unit 705 outputs, to the signal line DATAn-1, identification bits “High, High, Ignorable, Ignorable”, the value of which indicates that the data type is “Image”, in synchronization with rising of the line synchronization signal, and after that, transmits image data via the signal line DATAn-1. In the one-channel input mode, the data switching unit 705 does not transmit image data via the signal line DATAn-2. After receiving the identification bits “High, High, Ignorable, Ignorable”, the light-emitting chip 400 operates in such a way as to receive only data in the signal line DATAn-1 and not to receive data in the signal line DATAn-2. In the present embodiment, because of including 2,992 light-emitting points 602, the light-emitting chip 400 needs to transmit image data indicating light emission and light non-emission of the respective 2,992 light-emitting points 602 within a period of about 105.8 μs. Therefore, as illustrated in FIG. 10, at the time of transmission of image data, the data switching unit 705 sets the frequency of a clock signal to be transmitted to the signal line CLK to 30 megahertz (MHz). Thus, the frequency of a clock signal of the light-emitting chip 400 in the image reception state corresponds to a first drive frequency.

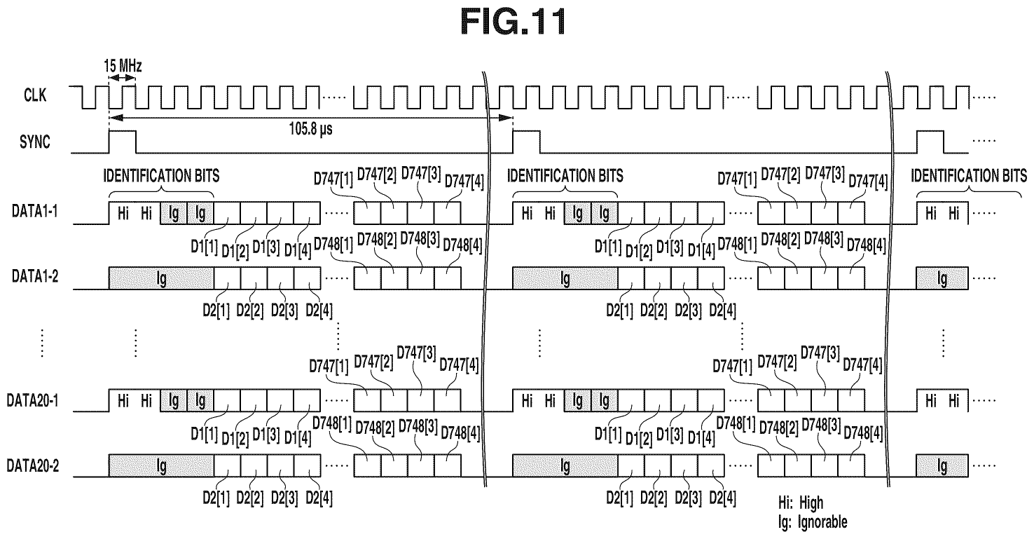

FIG. 11 illustrates signals in the respective signal lines in a case when the data switching unit 705 outputs image data to the light-emitting chip 400 in the two-channel input mode. In a case where the data type is “Image”, a line synchronization signal indicating exposure timing of one line in the photosensitive member 102 is output to the signal line SYNC. In the present example, the circumferential velocity of the photosensitive member 102 is set to 200 mm/s and the resolution in the sub-scanning direction is set to 1,200 dpi (about 21.16 μm). Accordingly, the line synchronization signal is output at intervals of about 105.8 μs, which is a period for which the surface of the photosensitive member 102 moves about 21.16 μm. The data switching unit 705 outputs, to the signal line DATAn-1, identification bits “High, High, Ignorable, Ignorable”, the value of which indicates that the data type is “Image”, in synchronization with rising of the line synchronization signal, and after that, transmits image data via the signal lines DATAn-1 and DATAn-2. In the two-channel input mode, after receiving the identification bits “High, High, Ignorable, Ignorable”, the light-emitting chip 400 operates in such a way as to receive data in the signal lines DATAn-1 and DATAn-2. In the present embodiment, because of including 2,992 light-emitting points 602, the light-emitting chip 400 needs to transmit image data indicating light emission and light non-emission of the respective 2,992 light-emitting points 602 within a period of about 105.8 us. Therefore, as illustrated in FIG. 11, at the time of transmission of image data, the data switching unit 705 sets the frequency of a clock signal to be transmitted to the signal line CLK to 15 MHz. As compared with the one-channel input mode, the two-channel input mode enables transmitting twice the amount of image data within the same time. Accordingly, if the print speed is the same, the frequency of image data in the two-channel input mode becomes half of the frequency in the one-channel input mode.

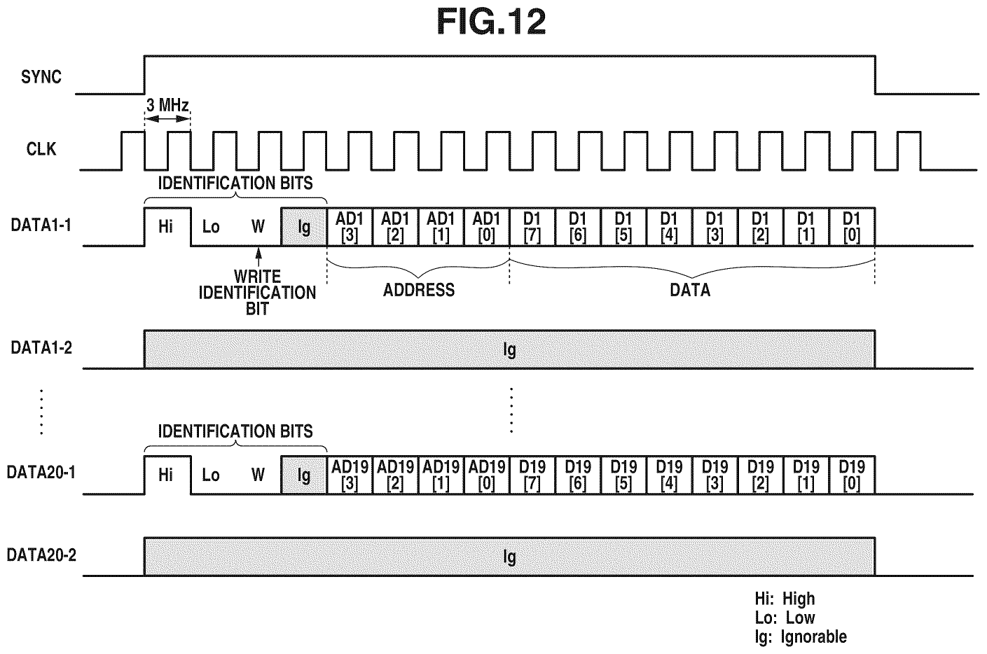

FIG. 12 illustrates signals in the respective signal lines in a case where the data switching unit 705 outputs control data (write) to the light-emitting chip 400. In a case where the data type is “Control (write)”, an enable signal which, during communication, becomes at high level and thus indicates that communication is in progress is output to the signal line SYNC.

The data switching unit 705 transmits, to the signal line DATAn-1, identification bits “High, Low, Low, Ignorable”, the value of which indicates that the data type is “Control (write)”, in synchronization with rising of the enable signal, and, after that, transmits the address (in the present example, four bits) of a register into which to write control data and the control data (in the present example, eight bits). Furthermore, a configuration of reversing the sequential order of transmission of the address and the control data can be employed. If the register of the light-emitting chip 400 has a single address, a configuration of, without performing addressing, transmitting only control data can be employed. In the case of transmitting control data (write), the data switching unit 705 does not transmit control data via the signal line DATAn-2. After receiving the identification bits “High, Low, Low, Ignorable”, the light-emitting chip 400 operates in such a way as to receive only data in the signal line DATAn-1 and not to receive data in the signal line DATAn-2. Since the data amount of control data (write) is smaller than the data amount of image data, it is possible to make the frequency of a clock signal to be output to the signal line CLK lower than that in transmitting image data. As an example, it is possible to set the frequency of a clock signal in transmitting control data (write) to 3 MHz. Furthermore, a configuration of making the frequency of a clock signal in transmitting control data (write) equal to that in transmitting image data can be employed.

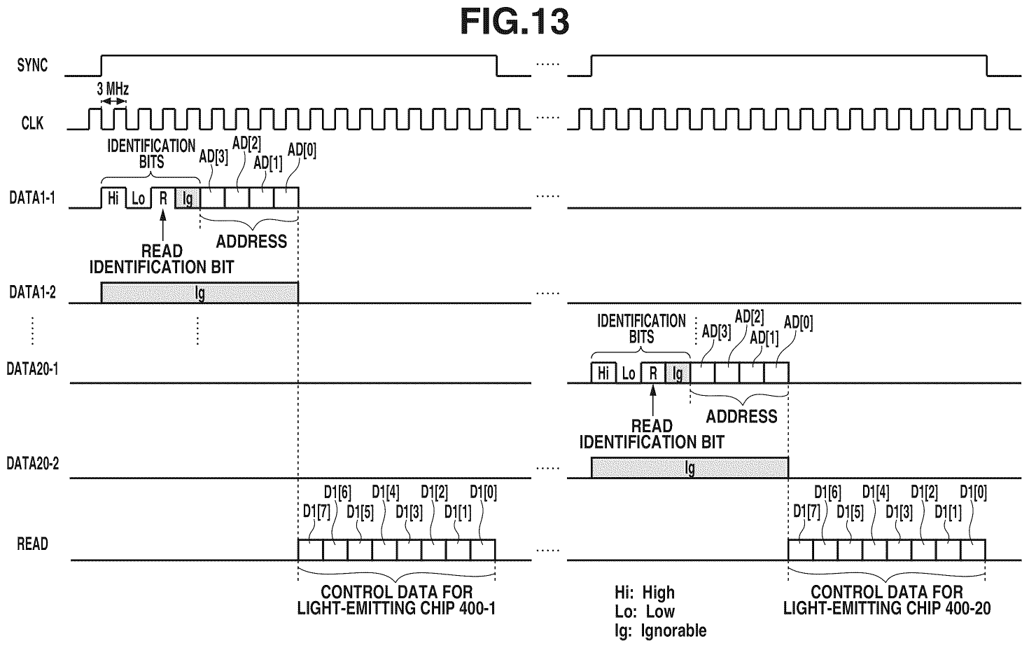

FIG. 13 illustrates signals in the respective signal lines in a case where the data switching unit 705 outputs control data (read) to the light-emitting chip 400. In a case where the data type is “Control (read)”, an enable signal which, during communication, becomes at high level and thus indicates that communication is in progress is output to the signal line SYNC.

The data switching unit 705 transmits, to the signal line DATAn-1, identification bits “High, Low, High, Ignorable”, the value of which indicates that the data type is “Control (read)”, in synchronization with rising of the enable signal, and, after that, transmits the address (in the present example, four bits) of a register from which to read out control data. Furthermore, if the register of the light-emitting chip 400 has a single address, a configuration of, without performing addressing, transmitting only control data can be employed. In the case of transmitting control data (read), the data switching unit 705 does not transmit control data via the signal line DATAn-2. After receiving the identification bits “High, Low, High, Ignorable”, the light-emitting chip 400 operates in such a way as to receive only data in the signal line DATAn-1 and not to receive data in the signal line DATAn-2. In response to control data (read) received from the data switching unit 705, the light-emitting chip 400-1 reads out control data stored in the designated address of the register and then outputs the control data to the signal line READ. Since, in the present embodiment, a single signal line READ is used for all of the light-emitting chips 400-1 to 400-20, the data switching unit 705 repeats similar processing operations on the light-emitting chips 400-2 to 400-20 in sequence. Since the data amount of control data (read) is smaller than the data amount of image data, it is possible to make the frequency of a clock signal to be output to the signal line CLK lower than that in transmitting image data. As an example, it is possible to set the frequency of a clock signal in transmitting control data (read) to 3 MHz. Furthermore, a configuration of making the frequency of a clock signal in transmitting control data (read) equal to that in transmitting image data can be employed. Thus, the drive frequency in the control state corresponds to a second drive frequency.

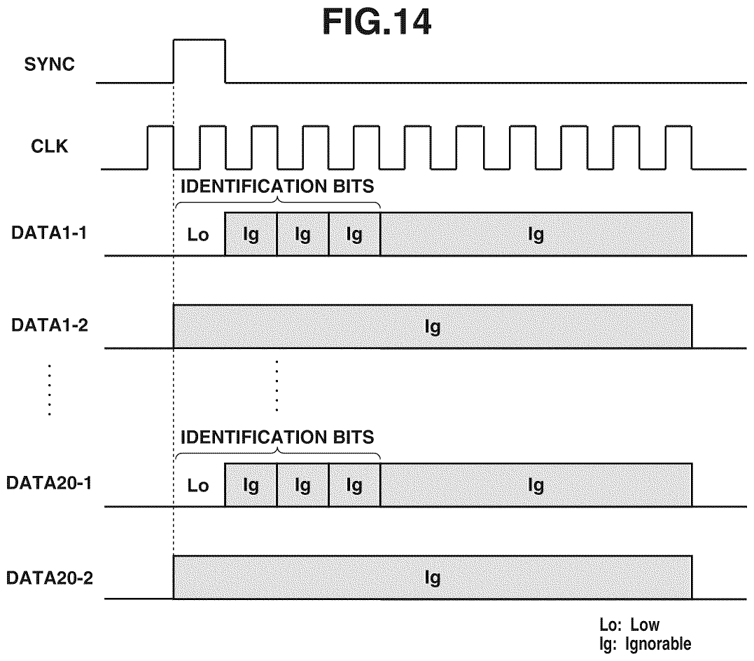

FIG. 14 illustrates signals in the respective signal lines in a case where the data switching unit 705 outputs, to the light-emitting chip 400, identification bits indicating that the data type is “Disabled”.

In a case where the data type is “Disabled”, a trigger signal indicating transmission of identification bits is output to the signal line SYNC. The data switching unit 705 transmits, to the signal line DATAn-1, identification bits “Low, Ignorable, Ignorable, Ignorable”, the value of which indicates that the data type is “Disabled”, in synchronization with rising of the trigger signal, and, after that, does not transmit control data. After receiving the identification bits “Low, Ignorable, Ignorable, Ignorable”, the light-emitting chip 400 operates in such a way as not to receive data in the signal lines DATAn-1 and DATAn-2 until receiving next identification bits. In the case of transmitting the data type “Disabled”, the data switching unit 705 is able to make the frequency of a clock signal to be output to the signal line CLK equal to that in transmitting image data. Alternatively, in the case of transmitting the data type “Disabled”, the data switching unit 705 is able to make the frequency of a clock signal to be output to the signal line CLK equal to that in accessing the register. Additionally, in the case of transmitting the data type “Disabled”, the data switching unit 705 is able to make the frequency of a clock signal to be output to the signal line CLK equal to the frequency used before transmitting the data type “Disabled”. Additionally, in the case of transmitting the data type “Disabled”, the data switching unit 705 is able to set the frequency of a clock signal to be output to the signal line CLK to a predetermined value different from the frequency in transmitting image data and the frequency in accessing the register.

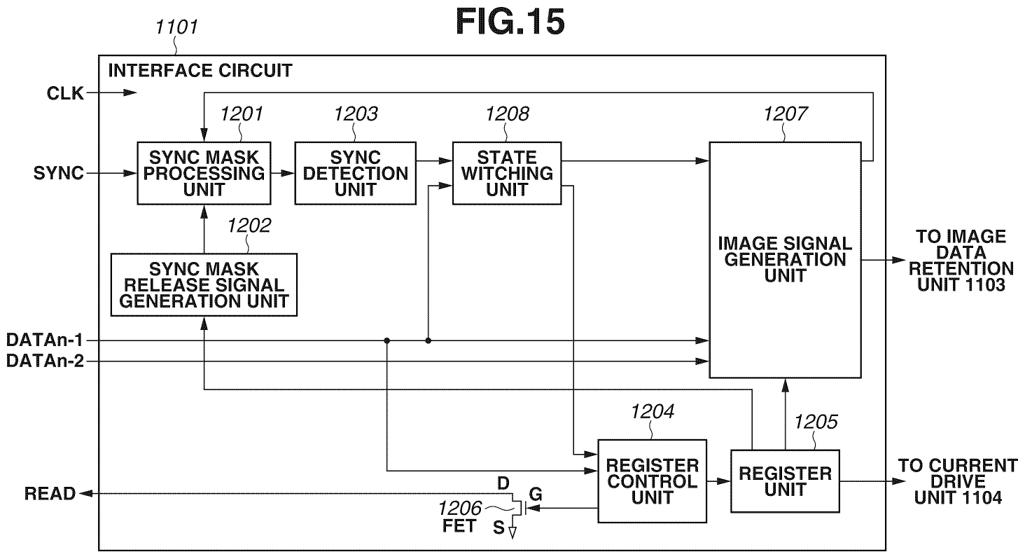

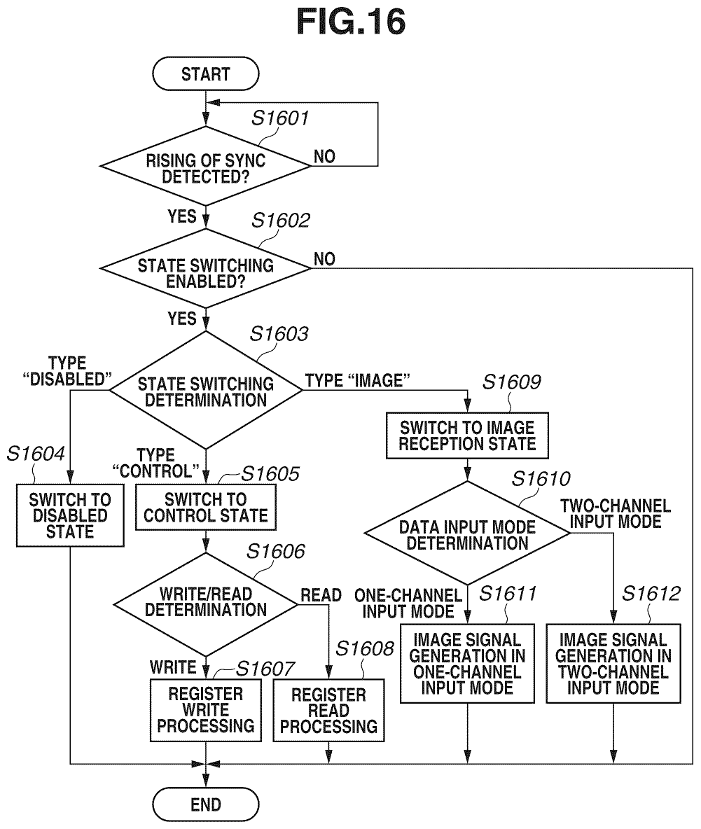

FIG. 15 is a block diagram of the interface circuit 1101. FIG. 16 is a flowchart of processing which the interface circuit 1101 performs. Internal processing which the interface circuit 1101 performs is described with reference to FIG. 15 and FIG. 16.

The interface circuit 1101 is a circuit which controls switching between the disabled state, the image reception state, and the control state based on identification bits (four bits) which are received in the signal line DATAn-1 in synchronization with rising of a signal which is received in the signal line SYNC. While, in the block diagram of FIG. 15, connection between the signal line CLK and the respective processing units is not illustrated, the signal line CLK is assumed to be connected to all of the processing units. Processing illustrated in the flowchart of FIG. 16 is started when the light-emitting chip 400 is in any one of the disabled state, the image reception state, and the control state.

In step S1601, a SYNC detection unit 1203 performs SYNC rising detection. The SYNC detection unit 1203 receives, via a SYNC mask processing unit 1201, a signal which the data switching unit 705 has transmitted to the signal line SYNC. The SYNC mask processing unit 1201 performs through-outputting of a signal in the signal line SYNC. When having received a High signal after a Low signal continues for a predetermined period, the SYNC detection unit 1203 determines that rising of a signal in the signal line SYNC has been detected (YES in step S1601). Then, the SYNC detection unit 1203 transmits a signal in the signal line SYNC to a state witching unit 1208, and then advances the processing to step S1602. In the present example, the predetermined period for which a Low signal continues is assumed to be 8 clocks. Furthermore, the predetermined period for which a Low signal continues does not need to be a fixed value, but can be configured to be changeable according to a setting value stored in a register unit 1205. On the other hand, when not having received a High signal after a Low signal continues for the predetermined period, the SYNC detection unit 1203 does not determine that rising of a signal in the signal line SYNC has been detected (NO in step S1601). Then, without transmitting a signal in the signal line SYNC to the state witching unit 1208, the SYNC detection unit 1203 repeats step S1601. For example, when having received a High signal after a Low signal continues for 4 clocks, the SYNC detection unit 1203 does not determine that rising of a signal in the signal line SYNC has been detected. In this way, performing SYNC rising detection enables preventing or reducing an issue in which an error occurs in a signal level in the signal line SYNC due to, for example, external noise or static electricity and the interface circuit 1101 thus malfunctions.

In step S1602, the state witching unit 1208 performs state switching enablement determination. The state witching unit 1208 performs state switching enablement determination based on identification bits (four bits) which are received in the signal line DATAn-1 in synchronization with rising of a signal in the signal line SYNC received from the SYNC detection unit 1203. In a case where the state transition is neither a direct transition from the image reception state to the control state nor a direct transition from the control state to the image reception state, the state witching unit 1208 determines that the state switching is enabled (YES in step S1602), and then advances the processing to step S1603. On the other hand, in a case where the state transition is Ignorable one of a direct transition from the image reception state to the control state and a direct transition from the control state to the image reception state, the state witching unit 1208 determines that the state switching is disabled (NO in step S1602), and then ends the processing illustrated in the flowchart of FIG. 16. In this way, disabling a direct transition from the image reception state to the control state and a direct transition from the control state to the image reception state enables preventing or reducing an issue in which an error occurs in identification bits due to, for example, external noise or static electricity and the interface circuit 1101 thus malfunctions.

In step S1603, the state witching unit 1208 performs state switching determination. In a case where the state witching unit 1208 has received identification bits “Low, Ignorable, Ignorable, Ignorable” indicating the type “Disabled” in the signal line DATAn-1 (TYPE “DISABLED” in step S1603), the state witching unit 1208 advances the processing to step S1604, in which the state witching unit 1208 switches the interface circuit 1101 to the disabled state. In a case where the state witching unit 1208 has received identification bits “High, Low, Low, Ignorable” or identification bits “High, Low, High, Ignorable” each indicating the type “Control” in the signal line DATAn-1 (TYPE “CONTROL” in step S1603), the state witching unit 1208 advances the processing to step S1605, in which the state witching unit 1208 switches the interface circuit 1101 to the control state. In a case where the state witching unit 1208 has received identification bits “High, High, Ignorable, Ignorable” indicating the type “Image” in the signal line DATAn-1 (TYPE “IMAGE” in step S1603), the state witching unit 1208 advances the processing to step S1609, in which the state witching unit 1208 switches the interface circuit 1101 to the image reception state.

In step S1604, the state witching unit 1208 switches the interface circuit 1101 to the disabled state. The state witching unit 1208 issues a notification for disabling processing to an image signal generation unit 1207 and a register control unit 1204, i.e. controller. This causes the image signal generation unit 1207 and the register control unit 1204 to be set in such a way as not to perform data transmission and reception with respect to another circuit. After switching the interface circuit 1101 to the disabled state, the state witching unit 1208 ends the processing illustrated in the flowchart of FIG. 16.

In step S1605, the state witching unit 1208 switches the interface circuit 1101 to the control state. The state witching unit 1208 issues a notification for enabling processing to the register control unit 1204 and issues a notification for disabling processing to the image signal generation unit 1207. This causes the register control unit 1204 to be set in such a way as to perform writing and reading of control data to and from the register unit 1205 based on data which is received in the signal line DATAn-1 following the identification bits. On the other hand, the image signal generation unit 1207 is set in such a way as not to perform data transmission and reception with respect to another circuit.

In step S1606, the register control unit 1204 performs write/read determination. In a case where the register control unit 1204 has received identification bits “High, Low, Low, Ignorable” indicating the type “Control” in the signal line DATAn-1, the register control unit 1204 determines that an instruction for a write communication for control data to the register unit 1205 has been received (WRITE in step S1606), and then advances the processing to step S1607. On the other hand, in a case where the register control unit 1204 has received identification bits “High, Low, High, Ignorable” indicating the type “Control” in the signal line DATAn-1, the register control unit 1204 determines that an instruction for a read communication for control data to the register unit 1205 has been received (READ in step S1606), and then advances the processing to step S1608.

In step S1607, the register control unit 1204 performs register write processing. The register control unit 1204 performs writing of control data to the register unit 1205 based on data which is received in the signal line DATAn-1 following the identification bits. Here, an example of the control data is described. When being subjected to writing of a setting value for designating the one-channel input mode or the two-channel input mode, the register unit 1205 notifies the image signal generation unit 1207 of the setting value. When being subjected to writing of a drive voltage setting value, the register unit 1205 notifies the current drive unit 1104 of the drive voltage setting value. When being subjected to writing of a setting value of SYNC mask duration time, the register unit 1205 notifies a SYNC mask release signal generation unit 1202 of the setting value of SYNC mask duration time. The SYNC mask duration time is described below.

In step S1608, the register control unit 1204 performs register read processing. The register control unit 1204 performs reading of control data from the register unit 1205 based on data which is received in the signal line DATAn-1 following the identification bits. After completion of the register read processing, the register control unit 1204 ends the processing illustrated in the flowchart of FIG. 16.

Here, a circuit configuration concerning the register read processing is described with reference to FIG. 7 and FIG. 15.

As described with reference to FIG. 7, the signal line READ is one signal line to which a total of 20 signal lines from the respective light-emitting chips 400-n are connected, and is pulled up to a predetermined first electric potential via the pull-up resistor 1506 in the printed circuit board 202. Additionally, in FIG. 15, the signal line READ is connected to the drain terminal of a field-effect transistor (FET) 1206. The source terminal of the FET 1206 is connected to a second electric potential (in the present example, ground), which is smaller than the first electric potential to which the pull-up resistor 1506 is connected. The gate terminal of the FET 1206 is connected to a terminal of the register control unit 1204 for transmitting control data read out from the register unit 1205. The FET 1206 is switched between a turning-on state and a turning-off state based on the level of a signal output from the register control unit 1204. When the FET 1206 is in the turning-on state, the signal line READ is connected to the second electric potential. When the FET 1206 is in the turning-off state, the signal line READ is disconnected from the second electric potential, so that the signal line READ enters into a high-impedance state.

While transmitting control data read out from the register unit 1205 to the data switching unit 705, the register control unit 1204 brings the FET 1206 into the turning-on state or the turning-off state according to the data value. When the FET 1206 is in the turning-on state, a low-level signal that is based on the second electric potential is output to the signal line READ. On the other hand, when the FET 1206 is in the turning-off state, a high-level signal that is based on the first electric potential is output to the signal line READ due to the pull-up resistor 1506. On the other hand, while not transmitting control data read out from the register unit 1205 to the data switching unit 705, the register control unit 1204 brings the FET 1206 into the turning-off state.

In this way, with the signal line READ being set as an open drain output configuration, since, while control data is being read out from a given light-emitting chip 400, another light-emitting chip 400 enters into a high-impedance state with respect to the signal line READ and thus does not affect the signal line READ, it is possible to share one signal line READ.

In step S1609, the state witching unit 1208 switches the interface circuit 1101 to the image reception state. The state witching unit 1208 issues a notification for enabling processing to the image signal generation unit 1207 and issues a notification for disabling processing to the register control unit 1204. This causes the image signal generation unit 1207 to be set in such a way as to perform generation of an image signal based on image data which is received in the signal lines DATAn-1 and DATAn-2 following the identification bits. On the other hand, the register control unit 1204 is set in such a way as not to perform data transmission and reception with respect to another circuit.

In step S1610, the image signal generation unit 1207 performs data input mode determination. In a case where the image signal generation unit 1207 has received, from the register unit 1205, a notification for setting the image signal generation unit 1207 to the one-channel input mode, the image signal generation unit 1207 determines that the image signal generation unit 1207 has been set to the one-channel input mode (ONE-CHANNEL INPUT MODE in step S1610), the image signal generation unit 1207 advances the processing to step S1611. On the other hand, in a case where the image signal generation unit 1207 has received, from the register unit 1205, a notification for setting the image signal generation unit 1207 to the two-channel input mode, the image signal generation unit 1207 determines that the image signal generation unit 1207 has been set to the two-channel input mode (TWO-CHANNEL INPUT MODE in step S1610), the image signal generation unit 1207 advances the processing to step S1612.

In step S1611, the image signal generation unit 1207 performs image signal generation in the one-channel input mode. Image data is input as serial data. The image signal generation unit 1207 performs serial to parallel conversion of image data which is received in the signal line DATAn-1 following the identification bits, and thus generates image data which is parallel data and transmits the generated parallel image data to the image data retention unit 1103. In the one-channel input mode, the image signal generation unit 1207 receives a signal in the signal line DATAn-1 and does not receive a signal in the signal line DATAn-2.

When starting transmission of image data to the image data retention unit 1103, the image signal generation unit 1207 notifies the SYNC mask processing unit 1201 of starting of SYNC mask processing. After receiving a notification of starting of SYNC mask processing, the SYNC mask processing unit 1201 performs such setting as not to receive a signal in the signal line SYNC which is transmitted from the data switching unit 705, and thus fixes the logic of a signal to be transmitted to the SYNC detection unit 1203. After that, when having received a SYNC mask release signal which is transmitted from the SYNC mask release signal generation unit 1202, the SYNC mask processing unit 1201 releases SYNC mask processing. After a time set from the time of starting of SYNC mask processing based on the setting value of a SYNC mask duration time notified from the register unit 1205 has elapsed, the SYNC mask release signal generation unit 1202 transmits a SYNC mask release signal to the SYNC mask processing unit 1201. The SYNC mask duration time is a value which is set in such a manner that SYNC mask processing is continued for a period in which to process image signal generation. In this way, performing SYNC mask processing enables preventing or reducing an issue in which an error occurs in a signal level in the signal line SYNC due to, for example, external noise or static electricity and the interface circuit 1101 thus malfunctions.

In step S1612, the image signal generation unit 1207 performs image signal generation in the two-channel input mode. The image signal generation unit 1207 performs serial to parallel conversion of image data which is received in the signal lines DATAn-1 and DATAn-2 following the identification bits received via the signal line DATAn-1, and thus generates image data corresponding to the light-emitting points 602 and transmits the generated image data to the image data retention unit 1103. In the two-channel input mode, the image signal generation unit 1207 receives signals in the signal lines DATAn-1 and DATAn-2. The SYNC mask processing is assumed to be performed in a manner similar to that in step S1611, and the description thereof is omitted here.

As described above, in the present embodiment, a configuration in which identification bits are input to the interface circuit 1101 with a one-channel signal is employed. A configuration is provided in which the interface circuit 1101 controls switching between the disabled state, the image reception state, and the control state based on identification bits which are received in the signal line DATAn-1 (one channel) in synchronization with rising of a signal which is received in the signal line SYNC is employed.

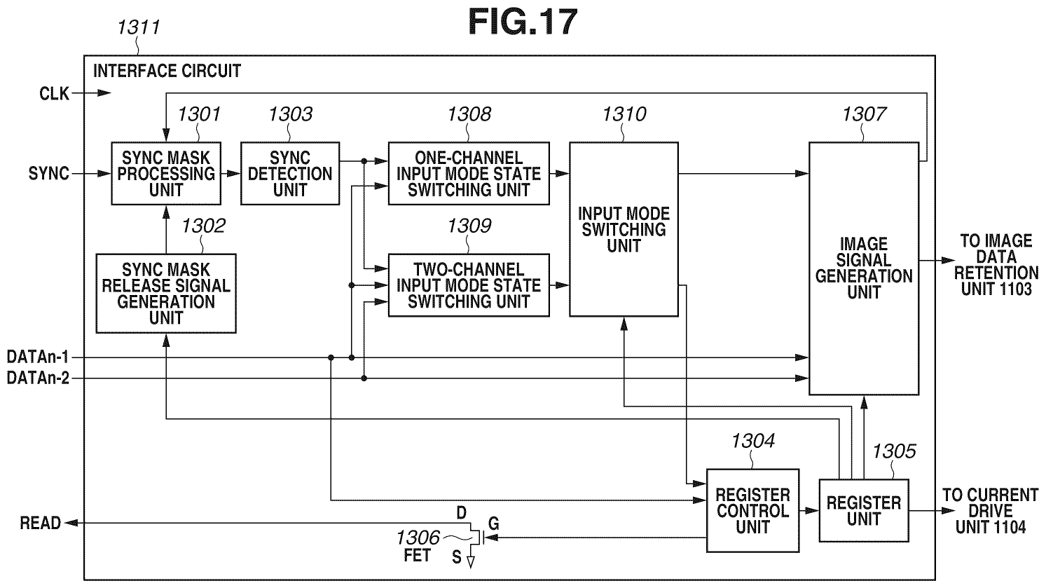

FIG. 17 illustrates a different configuration and embodiment. FIG. 17 is a functional block diagram of an interface circuit 1311, which receives, as an input, identification bits with two-channel signals. As illustrated in FIG. 17, a configuration is provided in which the interface circuit 1311 switches between the disabled state, the image reception state, and the control state based on identification bits which are received in the signal lines DATAn-1 and DATAn-2. The units 1301 to 1307 illustrated in FIG. 17 are functional blocks similar to those 1201 to 1207 illustrated in FIG. 15 and are, therefore, omitted from description here, and the following units 1308 to 1310 illustrated in FIG. 17 are described.

In the one-channel input mode, the data switching unit 705 transmits identification bits to the interface circuit 1311 via the signal line DATAn-1. A one-channel input mode state switching unit 1308 performs switching determination between the disabled state, the image reception state, and the control state based on identification bits which are received in the signal line DATAn-1 (one channel) in synchronization with rising of a signal in the signal line SYNC received from the SYNC detection unit 1303. Then, the one-channel input mode state switching unit 1308 issues a notification for enabling or disabling processing to the image signal generation unit 1307 and the register control unit 1304 via an input mode switching unit 1310.

In the two-channel input mode, the data switching unit 705 transmits identification bits to the interface circuit 1311 via the signal lines DATAn-1 and DATAn-2. A two-channel input mode state switching unit 1309 performs switching determination between the disabled state, the image reception state, and the control state based on identification bits which are received in the signal lines DATAn-1 and DATAn-2 (two channels) in synchronization with rising of a signal in the signal line SYNC received from the SYNC detection unit 1303. Then, the two-channel input mode state switching unit 1309 issues a notification for enabling or disabling processing to the image signal generation unit 1307 and the register control unit 1304 via an input mode switching unit 1310.

The input mode switching unit 1310 is notified of a setting value for designating the one-channel input mode or the two-channel input mode from the register unit 1305. When being set to the one-channel input mode, the input mode switching unit 1310 transmits the notification from the one-channel input mode state switching unit 1308 to the image signal generation unit 1307 and the register control unit 1304 and blocks the notification from the two-channel input mode state switching unit 1309 to the image signal generation unit 1307 and the register control unit 1304. On the other hand, when being set to the two-channel input mode, the input mode switching unit 1310 transmits the notification from the two-channel input mode state switching unit 1309 to the image signal generation unit 1307 and the register control unit 1304 and blocks the notification from the one-channel input mode state switching unit 1308 to the image signal generation unit 1307 and the register control unit 1304.

In a case where a configuration in which, as illustrated in FIG. 17, identification bits are input to the interface circuit 1311 with two-channel signals is employed, as compared with a configuration in which identification bits are input to an interface circuit with a one-channel signal, it is necessary to add the two-channel input mode state switching unit 1309 and the input mode switching unit 1310. Therefore, the circuit size of an interface circuit provided inside a light-emitting chip increases, so that the growth in size of the light-emitting chip and an increase in the cost of the light-emitting chip may be caused. Additionally, the growth in size of the light-emitting chip may lead to the growth in size of an exposure unit or a decrease in the arrangement density of light-emitting portions may cause a decrease in resolution.

Therefore, in the present embodiment, a configuration in which identification bits are input to an interface circuit with a one-channel signal is employed. A configuration is provided in which the interface circuit controls switching between the disabled state, the image reception state, and the control state based on identification bits which are received in the signal line DATAn-1 (one channel) in synchronization with rising of a signal which is received in the signal line SYNC is employed. This enables preventing or reducing an increase in the circuit size of an interface circuit provided inside a light-emitting chip and preventing or reducing the growth in size of a light-emitting chip.

In the present embodiment, a configuration in which the signal line DATAn-1, which is used for image data transmission in both the one-channel input mode and the two-channel input mode, is used at the time of transmission of identification bits is employed. This configuration enables sharing the state witching unit 1208 between the one-channel input mode and the two-channel input mode, thus enabling preventing or reducing an increase in the circuit size.

The present embodiment provides a configuration in which image data and control data are transmitted to each light-emitting chip via two signal lines. However, image data and control data may be transmitted to each light-emitting chip via three or more signal lines. As the number of signal lines via which to transmit image data is larger, the circuit size of an interface circuit provided inside a light-emitting chip increases. As with the present embodiment, employing a configuration in which identification bits are input to an interface circuit with a one-channel signal prevents and/or reduces an increase in the circuit size of an interface circuit provided inside a light-emitting chip and preventing or reducing the growth in size of a light-emitting chip and an increase in cost of a light-emitting chip.

The present embodiment describes specific numerical values as examples for the purpose of explanation, without being limited thereto. For example, the number of light-emitting chips 400 provided in one printed circuit board 202 is not limited to 20, but can be set to an optional number of 1 or more. The number of light-emitting points 602 included in each light-emitting chip 400 may be limited to 2,992, but can be another number. Moreover, while, in the present embodiment, the light-emitting points 602 are arranged at a pitch of about 21.16 μm, which corresponds to a resolution of 1,200 dpi, in the main scanning direction, the arrangement interval of light-emitting points 602 can also be another value.

While the present embodiment provides the state transition of the light-emitting chip 400 of three states, i.e., the disabled state, the image reception state, and the control state, a configuration which includes four or more states can be employed.

While the present disclosure has been described based on embodiments thereof, the present disclosure is not limited to such specific embodiments, and various configurations within a range not departing from the gist of the present disclosure are also included. The above-described embodiments are merely examples of implementation, and some or all of the embodiments can be combined as appropriate.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-076839 filed May 9, 2024, the entirety of which is incorporated herein by reference.

What is claimed is:

1. An image forming apparatus comprising:
a rotatable photosensitive member;
a light-emitting chip configured to emit light for exposing at least a portion of the photosensitive member, the light-emitting chip including a plurality of light-emitting portions arranged along an axis of rotation of the photosensitive member;
for controlling turning on and turning off at least one light-emitting portion of the plurality of light-emitting portions
a controller configured to output image data for controlling turning on and turning off at least one light-emitting portion of the plurality of light-emitting portions and control data for controlling an amount of light output by the at least one light-emitting portion;
a first signal line interconnecting the controller and the light-emitting chip, the first signal line configured to transmit the image data and the control data; and
a second signal line interconnecting the controller and the light-emitting chip, the second signal line configured to transmit the image data and the control data,
wherein the light-emitting chip is switchable between a first mode and a second mode,
wherein, in the first mode the light-emitting chip operates based on image data received via the first signal line and image data received via the second signal line,
wherein, in the second mode the light-emitting chip operates based on control data received via the first signal line and control data received via the second signal line, and
wherein the controller transmits, to the light-emitting chip via the first signal line, a switching signal for switching between the first mode and the second mode.

2. The image forming apparatus according to claim 1, wherein the controller is further configured to output the image data as serial data.

3. The image forming apparatus according to claim 2, wherein, when in the first mode, the light-emitting chip is further configured to convert serial image data received via the first signal line into parallel data and to convert serial image data received via the second signal line into parallel data.

4. The image forming apparatus according to claim 1, wherein the light-emitting chip is switchable between the first mode, the second mode, and a third mode in which the light-emitting chip does not operate based on the image data and does not operate based on the control data.

5. The image forming apparatus according to claim 4, wherein the controller is further configured to output a first signal for switching the light-emitting chip operating in the third mode to the first mode and a second signal for switching the light-emitting chip operating in the third mode to the second mode.

6. The image forming apparatus according to claim 5, wherein the controller is further configured to output a third signal for switching the light-emitting chip operating in the first mode to the third mode and switching the light-emitting chip operating in the second mode to the third mode.

7. The image forming apparatus according to claim 6,
wherein the switching signal includes the first signal and the third signal, and
wherein the light-emitting chip switches from the first mode to the third mode and then switches to the second mode.

8. The image forming apparatus according to claim 6,
wherein the switching signal includes the second signal and the third signal, and
wherein the light-emitting chip switches from the second mode to the third mode and then switches to the first mode.

9. The image forming apparatus according to claim 1, wherein a drive frequency for the light-emitting chip differs between the first mode and the second mode.

10. The image forming apparatus according to claim 1,
wherein, when in the first mode, the light-emitting chip is driven at a first drive frequency and, when in the second mode, the light-emitting chip is driven at a second drive frequency, and
wherein the first drive frequency is higher than the second drive frequency.

11. The image forming apparatus according to claim 1, wherein each of the plurality of light-emitting portions is an organic electroluminescent (EL) element.
